(19) United States
(12) Patent Application Publication
(10) Pub. No.: US 2008/0168519 A1
(43) Pub. Date: Jul. 10, 2008

(54) SYSTEM, METHOD AND APPARATUS FOR CONNECTING MULTIPLE AUDIO/VIDEO SOURCES TO AN AUDIO/VIDEO SINK

(75) Inventors: Tandhoni S. Rao, Ashland, MA (US); Samuel J. MacMullan, Carlisle, MA (US); Steven S. Fastert, Chelmsford, MA (US); Bhavin Patel, Somerville, MA (US); Donald W. Bryce, Framingham, MA (US)

Correspondence Address: FIALA & WEAVER, P.L.L.C.;C/O INTELLEVATE, P.O. BOX 52050, MINNEAPOLIS, MN, 55402, US

(73) Assignee: RADIOSPIRE NETWORKS, INC., Hudson, MA (US)

(21) Appl. No.: 11/968,563

(22) Filed: Jan. 2, 2008

Related U.S. Application Data
(60) Provisional application No. 60/878,677, filed on Jan. 5, 2007.

(51) Int. Cl. H04N 7/173

(52) U.S. Cl. 725/127

(57) ABSTRACT

An audio/video switching system is described that selectively enables multiple heterogeneous audio/video sources to transmit data to a single audio/video sink such as a display or audio/video repeater. The audio/video switching system supports format conversion to enable, for example, multiple different audio/video formats to be transmitted to the audio/video sink using a single link. In some implementations, the single link is a high-bandwidth, high-quality wireless link for carrying high definition and standard definition audio/video signals. Various home theater systems that include such an audio/video switching system are also described herein.

### CROSS-REFERENCE TO RELATED APPLICATIONS

This application claims priority to U.S. Provisional Application No. 60/878,677, filed Jan. 5, 2007 and entitled “System, Method and Apparatus for Connecting Multiple Audio/Video Sources to an Audio/Video Sink,” the entirety of which is incorporated by reference herein.

### BACKGROUND OF THE INVENTION

1. Field of the Invention

The invention is generally related to a system, method and apparatus for connecting multiple audio/video sources to a single audio/video sink, such as a display or audio/video repeater.

2. Background

The installation of home theater systems is often a vexing problem for consumers. This is due in part to the difficulty and expense associated with running cables from various pieces of source equipment to the display. This is also due in part to the fact that displays often have far fewer input connectors of a given type (e.g., CVBS/S-Video, component, RCA audio, DVI, HDMI, etc.) than are required for a particular home theater system. These two problems have become exacerbated by the recent consumer trend of wall-mounting displays and connecting to them an assortment of legacy source equipment, high-definition source equipment, and gaming consoles.

### BRIEF SUMMARY OF THE INVENTION

A system, method and apparatus are described herein that simplify the problem of connecting multiple pieces of audio/video source equipment to a single audio/video sink, such as a display or audio/video repeater. A particular embodiment of the present invention combines high-performance wireless technology with format conversion, audio/video switching, and remote control technology to greatly simplify the aforementioned connectivity problems. As a result, a consumer setting up an audio/video system, such as a home theater system, can be provided with significant benefits in terms of system aesthetics, equipment placement, installation and control.

In particular, an audio/video switching system is described herein that includes a transmitter unit and a receiver unit. The transmitter unit is configured to receive input signals from multiple audio/video sources, each of the multiple audio/video sources being adapted to transmit signals in accordance with a different audio/video signal format. The transmitter unit is further configured to selectively convert any one of the input signals from its corresponding audio/video signal format into a common audio/video signal format and to wirelessly transmit the converted signal. The receiver unit is configured to receive the wirelessly-transmitted signal and to convert the wirelessly-transmitted signal into an audio/video format suitable for wired transmission to an audio/video sink, such as a display or an audio/video repeater.

In the foregoing system, the audio/video format suitable for wired transmission to the audio/video sink may be a High Definition Multimedia Interface (HDMI) format and the audio/video signal format associated with the input signal selected for conversion may be one of: an HDMI format, a Digital Video Interface (DVI) format, a composite video (CVBS) format, an S-video format, a high definition or standard definition component video format, a DisplayPort format, a Unified Display Interface (UDI) format, a digital audio format, or an analog audio format.

The foregoing system may further include an audio/video device and the transmitter unit may be configured to extract an audio signal from a selected one of the input signals and to transmit the extracted audio signal to the audio/video device. Alternatively or additionally, the receiver unit may be configured to extract an audio signal from the wirelessly-transmitted signal and to transmit the extracted audio signal to the audio/video device. The audio/video device may be an audio/video receiver and the extracted audio signal may be a Sony/Philips Digital Interface (S/PDIF) or HDMI signal.

In the foregoing system, the transmitter unit may be configured to select one of the input signals for conversion and wireless transmission responsive to the receipt of a command from the user. The transmitter unit may be configured to receive the command from the user via a sensor, wherein the sensor is adapted to receive an infrared or radio frequency signal from a remote control unit. Alternatively, the receiver unit may be configured to receive the command from the user via a sensor and to forward the command to the transmitter unit via a wireless link.

In the foregoing system, the transmitter unit may also include an antenna for wirelessly transmitting the converted signal to the receiver unit, wherein the antenna is configured to allow the transmitter unit to be placed in multiple different orientations, including but not limited to either a vertical orientation or a horizontal orientation. The transmitter unit may also include at least one multiple-type single-input interface for receiving one of the input signals.

A transmitter unit is also described herein. The transmitter unit includes a first interface, a second interface, a third interface, and switching logic. The first interface is configured to receive from a first audio/video source a first input signal having a first signal format. The second interface is configured to receive from a second audio/video source a second input signal having a second signal format, wherein the second signal format is different from the first signal format. The switching logic is configured to selectively convert either the first input signal or the second input signal from its respective signal format to a common signal format. The third interface is configured to wirelessly transmit the converted signal to a receiver unit connected to an audio/video sink (such as a display or an audio/video repeater).

In accordance with the foregoing transmitter unit, the signal format associated with either the first input signal or the second input signal may be one of: an HDMI format, a DVI format, a CVBS format, an S-video format, a high definition or standard definition component video format, a DisplayPort format, a UDI format, a digital audio format, or an analog audio format.

The foregoing transmitter unit may further include a fourth interface configured to receive a command from a user and the switching logic may be configured to select either the first input signal or the second input signal for conversion responsive to the receipt of the command. The fourth interface may include a sensor for receiving an infrared or radio frequency signal from a remote control unit. Alternatively, the fourth interface may be configured to receive the user command from the receiver unit.

The foregoing transmitter unit may also include logic for extracting an audio signal from a selected one of the first input signal or the second input signal and a fourth interface configured to transmit the extracted audio signal to a device other than the audio/video sink. The extracted audio signal may be presented at the fourth interface as an S/PDIF or HDMI signal.

An alternative audio/video switching system is also described herein that includes a first transmitter unit, a second transmitter unit, and a receiver unit. The first transmitter unit is configured to receive a first plurality of input signals from a corresponding first plurality of audio/video sources and to selectively convert one of the first plurality of input signals into a format suitable for transmission over a first wireless link. The second transmitter unit is configured to receive a second plurality of input signals from a corresponding second plurality of audio/video sources and to selectively convert one of the second plurality of input signals into a format suitable for transmission over a second wireless link. The receiver unit is configured to selectively receive either a signal transmitted from the first transmitter unit over the first wireless link or a signal transmitted from the second transmitter unit over the second wireless link and to convert the received signal into a format suitable for wired transmission to an audio/video sink.

In the foregoing system, the first wireless link and the second wireless link may comprise a single spectrally-shared wireless link or separate spectrally-distinct wireless links.

In the foregoing system, the receiver unit may be configured to receive either the signal transmitted from the first transmitter unit over the first wireless link or the signal transmitted from the second transmitter over the second wireless link responsive to a command received from a remote control unit.

In the foregoing system, the receiver unit may be configured to wirelessly transmit a first command to the first transmitter unit to select one of the first plurality of input signals for conversion into a format suitable for transmission over the first wireless link and to wirelessly transmit a second command to the second transmitter unit to select one of the second plurality of input signals for conversion into a format suitable for transmission over the second wireless link. The receiver unit may be configured to wirelessly transmit the first or second command in response to a third command received from a remote control unit.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a conventional home theater system in which multiple pieces of audio/video source equipment are individually connected to a display using corresponding digital or analog cables.

FIG. 2 is a block diagram of a conventional home theater system that uses wired audio/video switches to reduce the number of cables required for connecting to a display.

FIG. 3 is a block diagram of a home theater system that includes a wired audio/video switch in accordance with an embodiment of the present invention.

FIG. 4 is a block diagram of a home theater system that includes a wireless audio/video switch in accordance with an alternate embodiment of the present invention.

FIG. 5 is an illustration of an example receiver unit in accordance with an embodiment of the present invention and connection of the receiver unit to a display and power supply.

FIG. 6 is a block diagram of a home theater system that includes a wireless audio/video switch in accordance with an embodiment of the present invention that extracts an audio signal from an input signal chosen by a user and provides the extracted audio signal to a device via an output interface of the switch.

FIG. 7 is a block diagram of a home theater system in accordance with an embodiment of the present invention in which multiple wireless audio/video switches are in communication with a single display and wherein a remote control unit is used for link selection and input port selection.

FIG. 8 shows a front right elevation view of a wireless audio/video switch in accordance with an embodiment of the present invention.

FIG. 9 shows a front right elevation view of an alternate wireless audio/video switch together with a companion remote control unit in accordance with an embodiment of the present invention.

FIG. 10 shows a back panel view of an exemplary wireless audio/video switch in accordance with an embodiment of the present invention.

FIG. 11 shows a back panel view of an exemplary wireless audio/video switch in accordance with an alternate embodiment of the present invention that includes a plurality of multiple-type single input interfaces.

FIG. 12 illustrates a wireless audio/video switch in accordance with an embodiment of the present invention that is capable of being oriented either vertically or horizontally.

FIG. 13 is a block diagram an audio/video switching system in accordance with an alternate embodiment of the present invention in which a receiver units configured to convert a wirelessly-received signal from a transmitter unit into one or more of a plurality of output signal formats for wired transmission to an audio/video sink.

FIG. 14 is a block diagram of an audio/video switching system in accordance with an alternate embodiment of the present invention in which audio signal extraction logic is implemented within a receiver unit rather than, or in addition to, a transmitter unit.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The present invention is directed to a system, method and apparatus that simplify the problem of connecting multiple pieces of audio/video source equipment to a single audio/video sink, such as a display or audio/video repeater, as is generally the case in home theater installation. An embodiment of the present invention is ideally suited for replacing a “brute force” approach in which individual cables of potentially differing types are used to individually connect multiple pieces of audio/video source equipment to a single display or repeater.

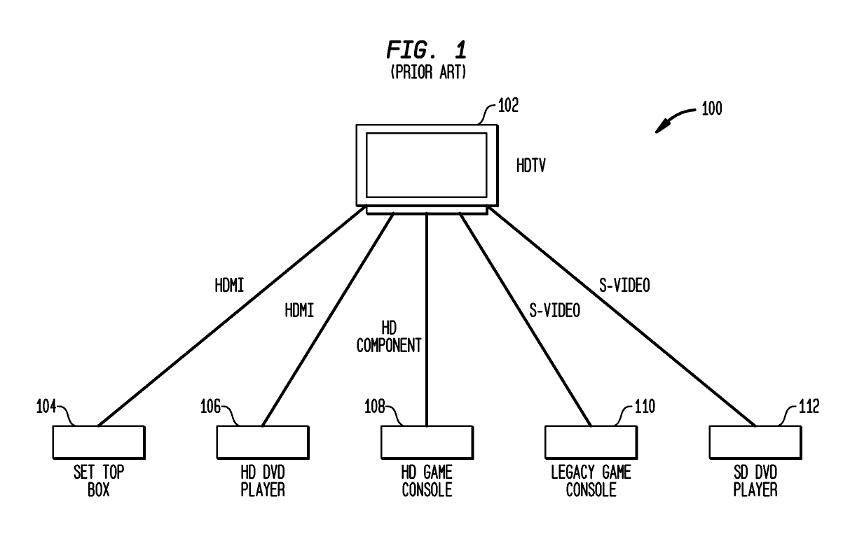

FIG. 1 is a block diagram of a conventional home theater system 100 in which pieces of audio/video source equipment are each individually connected to a single high definition television (HDTV) 102 using a corresponding digital or analog cable. In particular, home theater system 100 includes a set top box 104 connected to HDTV 102 via a High Definition Multimedia Interface (HDMI) cable, a high definition (HD) digital video disc (DVD) player 106 connected to HDTV 102 via an HDMI cable, an HD game console 108 connected to HDTV 102 via HD component cables, a legacy game console 110 connected to HDTV 102 via an S-video cable, and a standard definition (SD) DVD player connected to HDTV 102 via an S-video cable. As shown in FIG. 1, this “brute force” approach results in multiple cables being run to HDTV 102. Not only is this approach aesthetically unattractive for most consumers, but for situations where the display is located at a distance from the source equipment the cost of the cables themselves can be prohibitive.

To avoid the “brute force” approach exemplified by home theater system 100 and to minimize the number of cables needed to be connected to the display, manufacturers have developed so-called “switches” that are capable of receiving multiple input signals from respective pieces of audio/video source equipment and that allow a user to select only one of the multiple input signals for output to a display over a single cable. Some examples of wired HDMI switches that are currently available to consumers include the Radiient Select-4™ Four Input HDMI Switch/Repeater (sold by Radiient Technologies of Santa Clara, Calif.), the Belkin Pure AV™ HDMI Interface 3-to-1 Video Switch (sold by Belkin International, Inc. of Compton, Calif.), and the Gefen 4×2 HDMI Switcher (sold by Gefen, Inc. of Woodland Hills, Calif.). Various wired S-Video and wired component switches are also currently available to consumers.

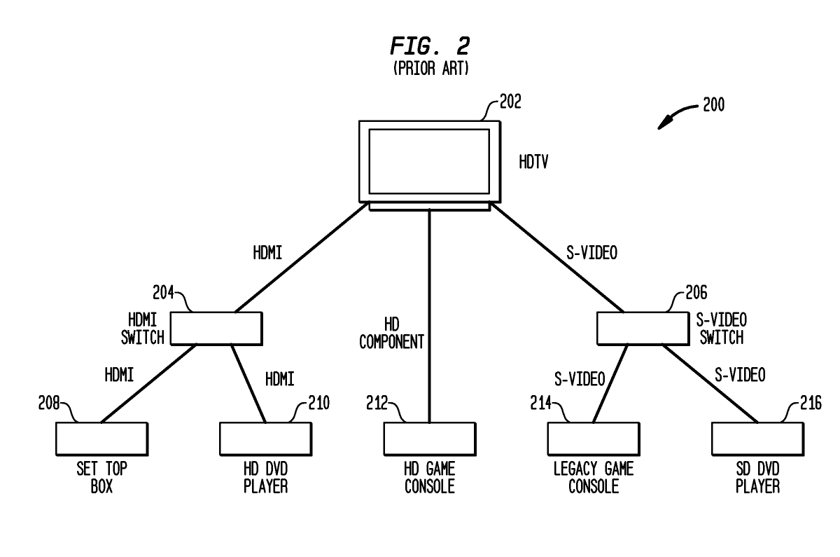

FIG. 2 is a block diagram of a conventional home theater system 200 that uses wired audio/video switches such as those described in the previous paragraph. In particular, home theater system 200 includes a set top box 208 and an HD DVD player 210 that are each connected to an HDMI switch 204 via corresponding HDMI cables. HDMI switch 204 allows a user to selectively send signals received from either set top box 208 or HD DVD player 210 to HDTV 202 via a single HDMI cable. Home theater system 200 also includes a legacy game console 214 and an SD DVD player 216 that are each connected to an S-Video switch 206 via corresponding S-Video cables. S-Video switch 206 allows a user to selectively send signals received from either legacy game console 214 or SD DVD player 216 to HDTV 202 via a single S-Video cable. An HD game console 212 is connected to HDTV 202 via HD component cables.

As shown in FIG. 2, the use of conventional wired audio/video switches does indeed reduce the number of cables needed for connecting different types of audio/video source equipment to a display. However, this conventional approach is still limited in that each wired audio/video switch is only capable of receiving and outputting a single type of signal (e.g., HDMI, S-Video, component, etc.). Thus, a consumer can use each switch only to connect a single type of audio/video source equipment to a display.

### B. Audio/Video Switching System in Accordance with an Embodiment of the Present Invention

As will be described in more detail below, an implementation of the present invention provides a cost-effective audio/video switching system having one or more of the following attributes: (1) the capability of accepting inputs from a number of different types of audio/video source equipment, (2) the capability of supporting different types of analog and digital connectivity interfaces, (3) the capability of being controlled via an external infrared or radio frequency (RF) wireless remote control unit, (4) the capability of supporting the equivalent digital data rates associated with a chosen audio/video connectivity format and/or interface without compression, (5) the capability of providing an acceptable level of noise immunity over a wireless link, and (6) the capability of producing an HDMI signal at the output of a wireless receiver unit which can then be presented via wire to the display.

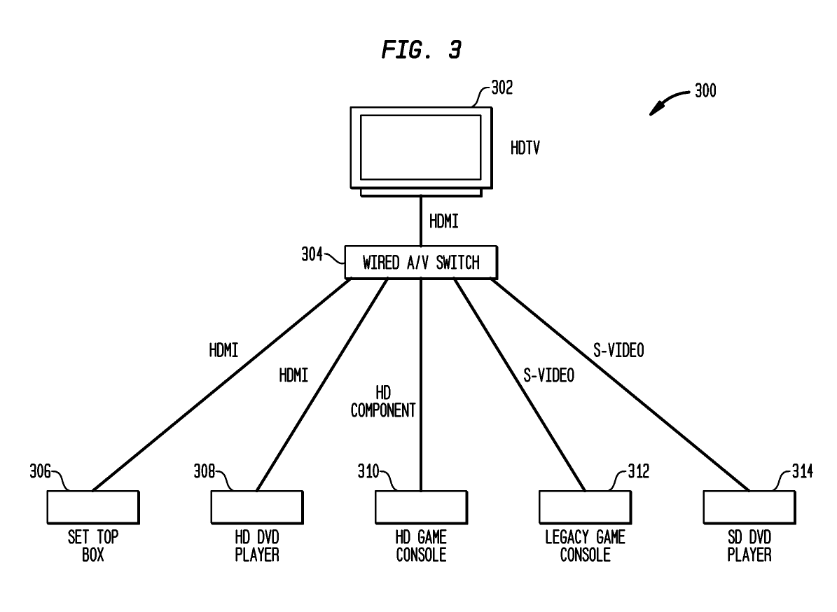

FIG. 3 is a block diagram of a home theater system 300 that includes a wired audio/video switch 304 in accordance with an embodiment of the present invention. Unlike the conventional audio/video switches discussed in the previous section, wired audio/video switch 304 is designed to accept digital and/or audio input signals of different types from respective pieces of audio/video source equipment. These different types of input signals may include, for example, an HDMI input signal, a DVI input signal, a composite video (CVBS) input signal, a S-Video input signal, a high definition or standard definition component video input signal, a DisplayPort input signal, a Unified Display Interface (UDI) input signal, a digital audio input signal, or an analog audio input signal. Thus, as shown in FIG. 3, wired audio/video switch 304 may receive HDMI input signals from a set top box 306 and an HD DVD player 308, HD component input signals from an HD game console 310, and S-Video input signals from a legacy game console 312 and an SD DVD player 314.

Wired audio/video switch 304 includes format and interface conversion logic for converting each of the input signals into a common output signal format for wired transmission to a display over a single output interface. In system 300, the display is an HDTV 302 and the single output interface is an HDMI cable. A consumer controls wired audio/video switch 304 to select which input signal is to be converted for output via the single output cable to the display. For example, such control may be implemented by transmitting infrared (IR) or radio frequency (RF) commands from a remote control unit to a sensor on wired audio/video switch 304.

In the embodiment of the invention depicted in FIG. 3, the output signal format/interface is HDMI, although other formats/interfaces can be used. As will be appreciated by persons skilled in the relevant art(s), the use of HDMI as the output signal format/interface is advantageous because a single HDMI cable is capable of carrying standard definition as well as high definition audio and video signals.

The use of a wired audio/video switch such as switch 304 depicted in FIG. 3 is advantageous because it permits a consumer to connect multiple pieces of audio/video source equipment, each providing a potentially different input signal format/interface, to a display using only a single wired connection. This not only reduces the number of cables required to be brought out and connected to the display, but also can reduce the number of audio/video switches required for installing a home theater system. The use of such an audio/video switch also minimizes the risk that the display will not have enough input connectors of a given type for a particular home theater installation. Furthermore, the use of a single wired connection to the display ensures that the installation will be as aesthetically pleasing as possible by reducing the number of visible cables in the vicinity of the display. This is a particular concern where the display is mounted on a wall, thus making cables difficult to hide.

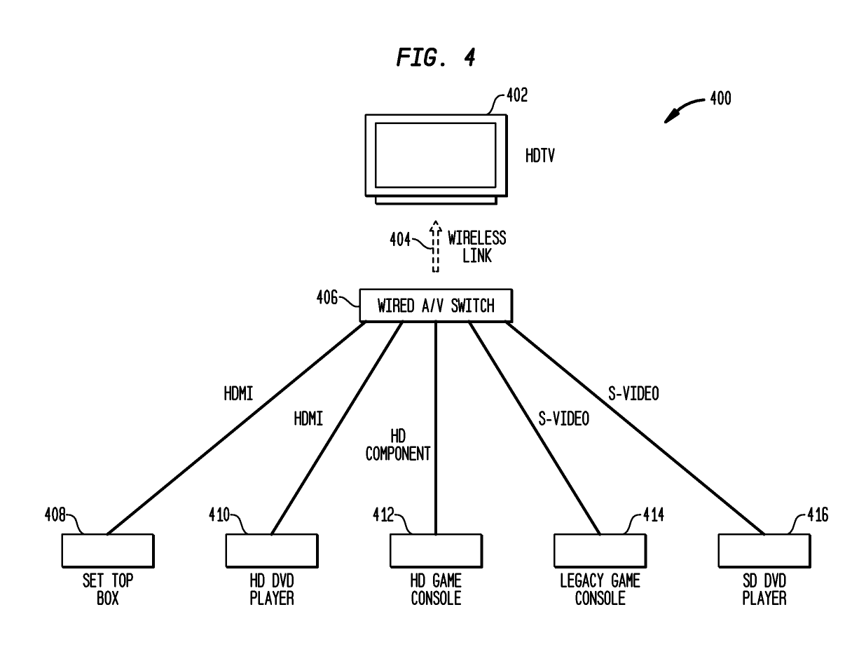

FIG. 4 is a block diagram of a home theater system 400 that includes a wireless audio/video switch 404 (or “transmitter unit”) in accordance with an alternate embodiment of the present invention. Like wired audio/video switch 304 of FIG. 3, wireless audio/video switch 406 is designed to accept digital and/or audio input signals of different types from respective pieces of audio/video source equipment and includes format and interface conversion logic for converting each of the input signals into a common output signal format. These different types of input signals may include, for example, an HDMI input signal, a DVI input signal, a CVBS input signal, a S-Video input signal, a high definition or standard definition component video input signal, a DisplayPort input signal, a Unified Display Interface (UDI) input signal, a digital audio input signal, or an analog audio input signal. Thus, as shown in FIG. 4, wireless audio/video switch 406 may receive HDMI input signals from a set top box 408 and an HD DVD player 410, HD component input signals from an HD game console 412, and S-Video input signals from a legacy game console 414 and an SD DVD player 416.

However, in contrast to wired audio/video switch 304, wireless audio/video switch 406 further includes logic for transmitting the output signal to the display (HDTV 402) over a high-bandwidth, high-quality wireless link 404. In accordance with this embodiment, the installation also includes a receiver unit (not shown in FIG. 4) that is placed in close proximity to the display. The receiver unit receives the wirelessly-transmitted output signal from wireless audio/video switch 406 and converts it into a format suitable for wired transmission to the display (e.g., HDMI). This signal is then passed over a short cable to an input of the display.

A description of logic that may be used for wirelessly transmitting an HDMI input signal (or input signals having other audio/video formats) from wireless audio/video switch 406 to the receiver unit is described in detail in commonly-owned, co-pending U.S. patent application Ser. Nos. 11/117,467, 11/190,878, 11/211,082 and 11/216,173, each of which is incorporated by reference as if fully set forth herein. As more fully described in those applications, the use of such logic provides a distinct advantage over the use of a general-purpose wireless transmission solution, such as a solution based on IEEE 802.11a/b/g or 802.15.3a, since it is capable of meeting the throughput, quality and cost considerations of the present application.

Although the foregoing description describes the transmission of a single output signal from wireless audio/video switch 406 to a receiver unit over a single wireless link, this is not intended to limit the present invention. Rather, persons skilled in the relevant art(s) will appreciate that in alternate embodiments of the present invention, wireless audio/video switch 406 may transmit multiple output signals over one or more wireless links to the receiver unit.

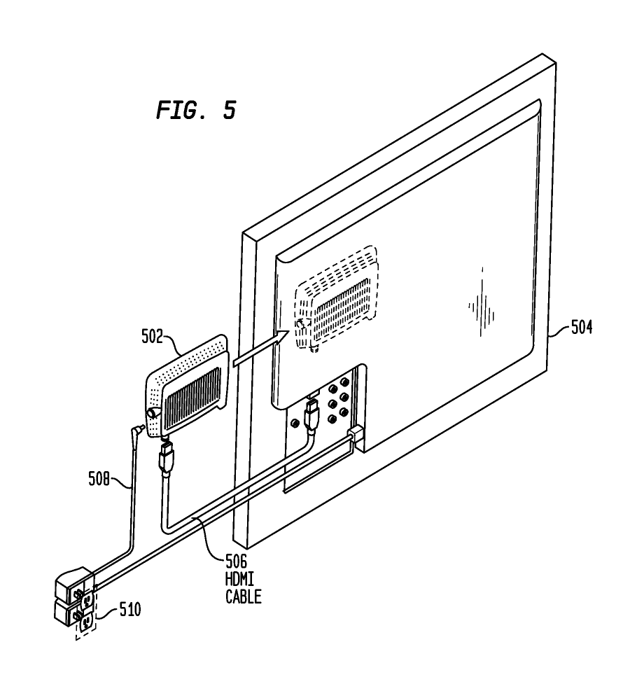

FIG. 5 depicts an example receiver unit 502 that may be used to implement home theater system 400 depicted in FIG. 4. As shown in FIG. 5, receiver unit 502 may optionally be mounted on the back of a flat-panel HDTV 504 or other display for easy connection to the display via an HDMI cable 506. As further shown in FIG. 5, receiver unit 502 may also be powered by a wired connection 508 to a DC power supply 510. However, alternate powering methods may be used.

In addition to providing the same advantages as wired audio/video switch 304 as discussed above in reference to FIG. 3, the use of wireless audio/video switch 406 as shown in FIG. 4 and a receiver unit 502 as shown in FIG. 5 provides the additional benefit of obviating the need for any cable between the audio/video switch and the display.

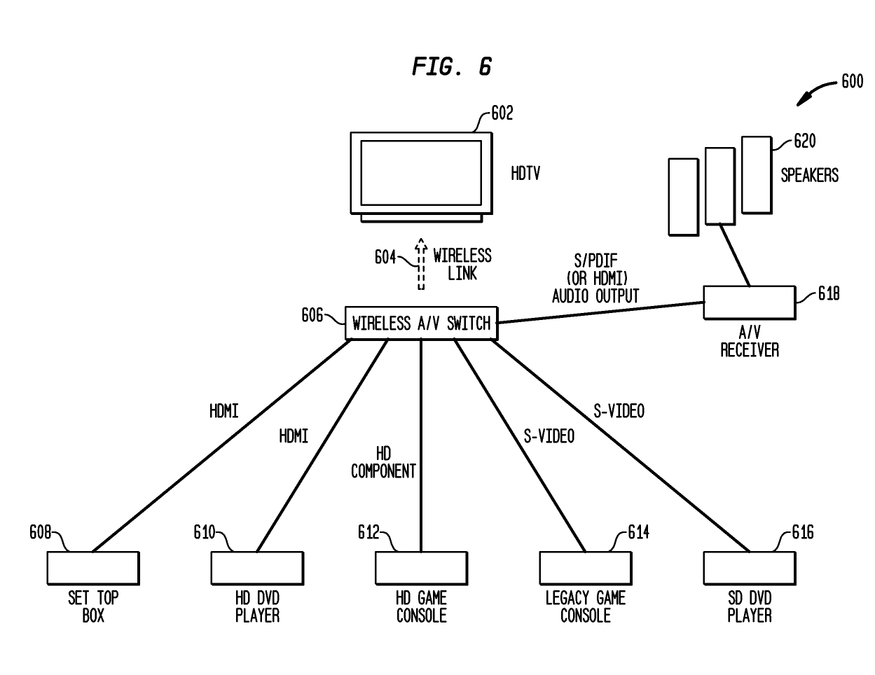

FIG. 6 is a block diagram of a home theater system 600 that uses a wireless audio/video switch 606 (or “transmitter unit”) in accordance with an alternate embodiment of the present invention. In addition to the features described above with respect to wireless audio/video switch 406 of FIG. 4, wireless audio/video switch 606 of FIG. 6 includes additional logic that extracts an audio signal from an input signal chosen by a user and provides the extracted audio signal to a device via an output interface of switch 606. The signal is provided to the device instead of (or in addition to) being related to the display. In the example implementation shown in FIG. 6, wireless audio/video switch 606 extracts the audio signal and outputs it to a wired Sony/Philips Digital Interface (S/PDIF) or HDMI interface which is connected to an audio/video receiver 618 (e.g., a surround sound audio/video receiver) with associated speakers 620. This is a desirable configuration, since home theater installations often make use of surround sound speakers that are controlled by an audio/video receiver. In an alternate implementation, the audio signal may be presented to the audio/video receiver 618 via a wireless link.

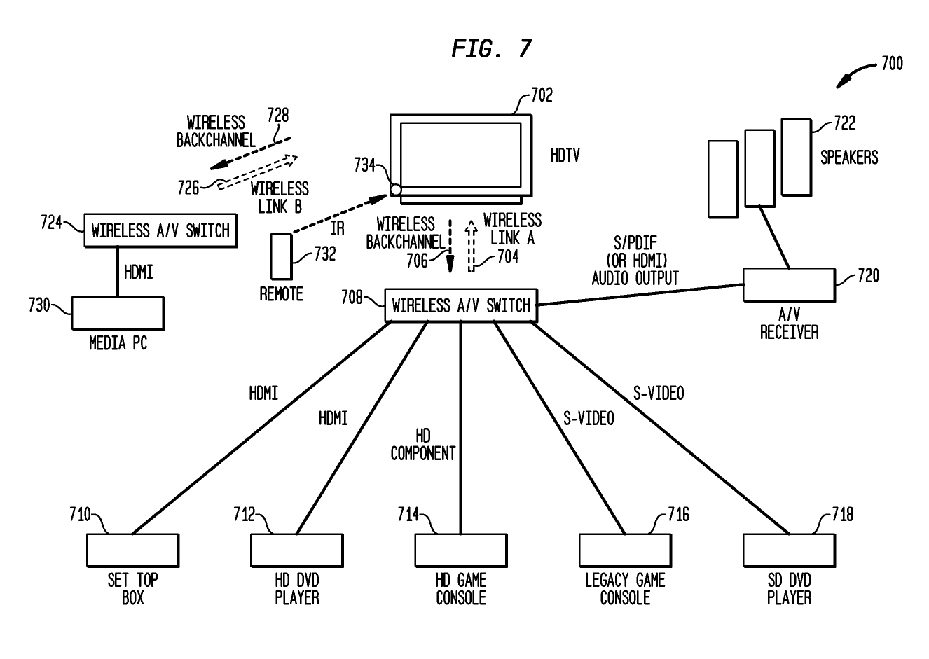

FIG. 7 is a block diagram of a home theater system 700 in accordance with an embodiment of the present invention in which multiple wireless audio/video switches 708 and 724 (or “transmitter units”) are in communication with a single display 702 and wherein a remote control unit 732 is used for link selection and input port selection. As shown in FIG. 7, wireless audio/video switch 708 is used to connect a set top box 710, an HD DVD player 712, an HD game console 714, a legacy game console 716 and an SD DVD player 718 to HDTV 702 while wireless audio/video switch is used to connect a media PC 730 to HDTV 702.

In this embodiment, the receiver unit connected to the display includes a sensor 734 that can be placed anywhere near display 702. Sensor 734 may be for example an infrared (IR) or radio frequency (RF) sensor. The receiver unit is configured to decode a remote control command received from remote control unit 732 by sensor 734 and to wirelessly relay a control message to wireless audio/video switches 708 and 724 via wireless backchannels 706 and 728, respectively. The control message indicates which input port on switches 708 and 724 is to be switched to display 702. Signals originating from source equipment attached to the switches may then be transmitted either from switch 708 to the receiver unit on HDTV 702 via a wireless link 704 (denoted “Wireless Link A”) or from switch 724 to the receiver unit on HDTV 702 via a wireless link 726 (denoted “Wireless Link B”). In one embodiment, wireless link 704 and wireless link 726 comprise a single spectrally-shared wireless link, while in an alternate embodiment wireless link 704 and wireless link 726 comprise separate spectrally-distinct wireless links. As will be appreciated by persons skilled in the relevant art(s), wireless links 704 and 726 may also have partially overlapping frequency ranges.

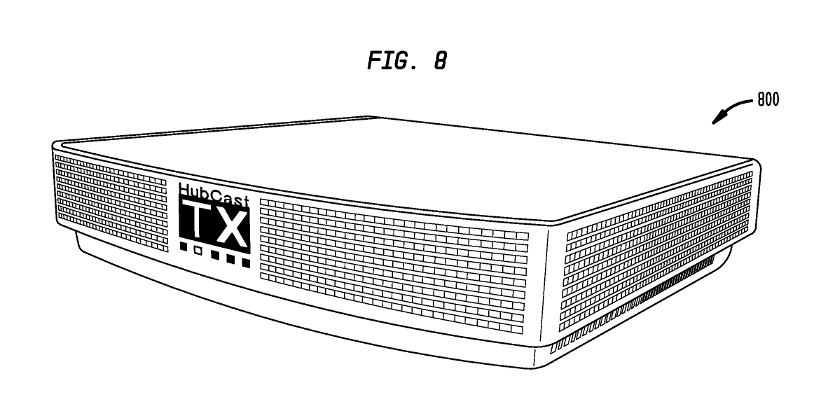

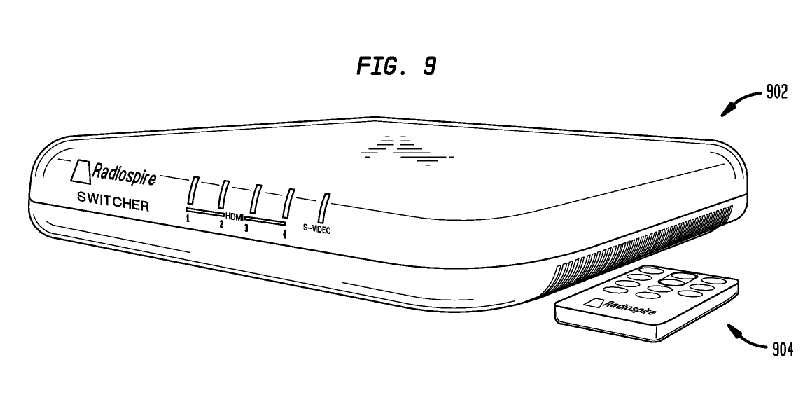

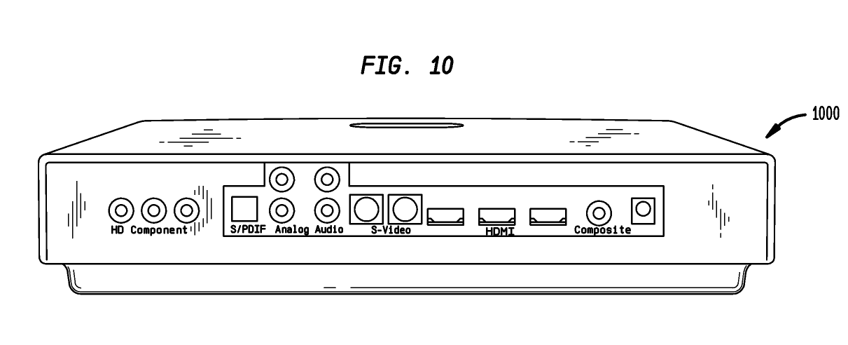

Persons skilled in the relevant art(s) will readily appreciate that the placement of the sensor near display 702 allows a consumer to control the switching in a natural manner without having to point the remote at switches 708 and 724 which may be located behind them or in an enclosed area. In an alternative implementation, a sensor for receiving using commands may additionally or alternatively be included on either or both of switches 708 and 724. FIG. 8 shows a front right elevation view of a wireless audio/video switch in accordance with one embodiment of the present invention. FIG. 9 shows a front right elevation view of an alternate wireless audio/video switch 902 together with a companion remote control unit 904 in accordance with an embodiment of the present invention. FIG. 10 shows a back panel view of an exemplary wireless audio/video switch 1000 in accordance with an embodiment of the present invention. As shown in FIG. 10, the back panel of switch 100 includes a variety of standard definition and high definition input signal interfaces. These include an HD component interface, an S/PDIF interface, an analog audio interface, S-Video interfaces, HDMI interfaces, and a composite interface.

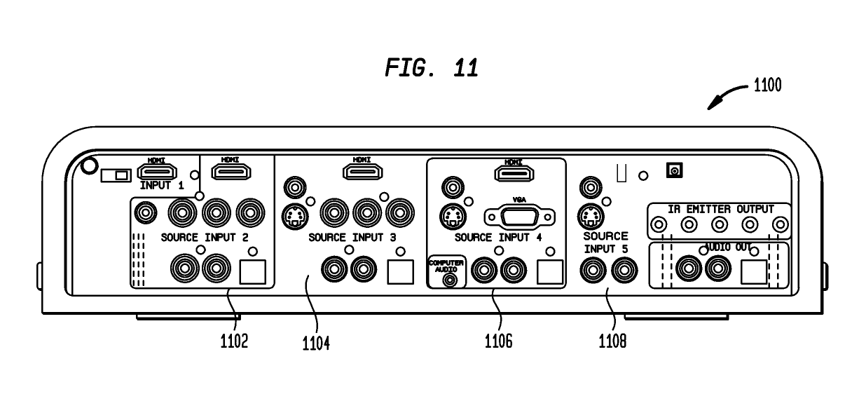

FIG. 11 shows a back panel view of an exemplary wireless audio/video switch 1100 in accordance with an alternate embodiment of the present invention. As shown in FIG. 11, wireless audio/video switch 1100 advantageously includes a plurality of multiple-type single input interfaces 1102, 1104, 1106 and 1108. As used herein, the term “multiple-type single input interface” refers to an interface that supports multiple inputs of different types (e.g., HDMI, CVBS/S-Video, DVI, component, etc.) wherein only one of the multiple inputs can be activated for that interface. Thus, for example, interface 1102 (denoted “Source Input 2”) of wireless audio/video switch 1100 includes an HDMI video port, an HD component video port and a composite video port; however, a user can only use one of these video input ports at a time. Wireless audio/video switch 110 may be configured to determine which port has been activated via a “hot-plug” process, a menu configuration process, or via some other process. The inclusion of such multiple-type single input interfaces in wireless audio/video switch 1100 advantageously provides a user with increased flexibility in connecting audio/video source equipment to the switch.

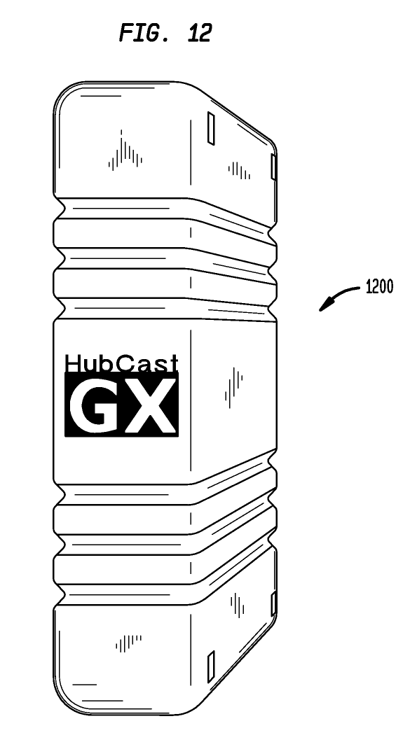

Wireless devices are often sensitive to orientation due to the placement and design of the antennas associated with such devices. A further embodiment of a wireless audio/video switch in accordance with the present invention includes an antenna that is designed to allow the unit to be placed in a plurality of orientations, including but not limited to a vertical or horizontal orientation, thereby greatly facilitating co-location of the switches with other consumer electronic equipment. FIG. 12 illustrates such a wireless audio/video switch 1200 that is capable of being oriented either vertically or horizontally. It should be noted that the antenna of a wireless audio/video switch in accordance with the present invention may either be internal or external with respect to the switch depending upon the implementation.

### C. Alternative Implementations

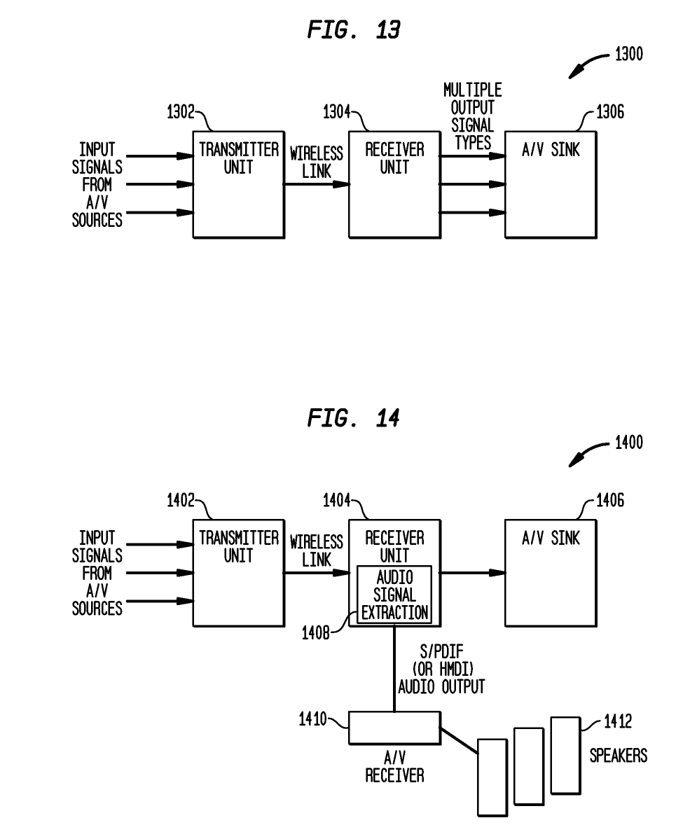

As discussed above, a receiver unit in accordance with one embodiment of the present invention is configured to receive a wirelessly-transmitted output signal from a wireless audio/video switch (or “transmitter unit”) and to convert it into a single format suitable for wired transmission to the display, such as HDMI. FIG. 13 is a block diagram of an audio/video switching system 1300 in accordance with an alternate embodiment of the present invention in which the receiver unit is configured to receive the wirelessly-transmitted output signal from the transmitter unit and to convert the signal into one or more of a plurality of output signal formats for wired transmission to an audio/video sink.

In particular, as shown in FIG. 13, system 1300 includes a transmitter unit 1302, a receiver unit 1304 and an audio/video sink 1306. Transmitter unit 1302 is configured to receive input signals from a plurality of audio/video sources, wherein each of the plurality of audio/video sources is adapted to transmit signals in accordance with a different audio/video signal format, and to selectively convert any one of the input signals into a common signal format for subsequent transmission over a wireless link. Receiver unit 1304 is configured to receive the wirelessly-transmitted signal over the wireless link and to convert the wirelessly-received signal into one or more of a plurality of different output signal formats, each of which is suitable for wired transmission to an audio/video sink 1306. The different output signal formats may be, for example, any one of an HDMI format, a DVI format, a CVBS format, an S-Video format, a high definition or standard definition video format, a DisplayPort format, a UDI format, a digital audio format or and analog audio format.

As also discussed above, an audio/video switch (or “transmitter unit”) in accordance with one embodiment of the present invention includes logic that extracts an audio signal from an input signal chosen by a user and provides the extracted audio signal to a device via an output interface of the switch, such as a wired S/PDIF or HDMI interface. FIG. 14 is a block diagram of an audio/video switching system 1400 in accordance with an alternate embodiment of the present invention in which the audio signal extraction logic is implemented within a receiver unit rather than (or in addition to) a transmitter unit.

In particular, as shown in FIG. 14, system 1400 includes a transmitter unit 1402, a receiver unit 1404 and an audio/video sink 1406. Transmitter unit 1402 is configured to receive input signals from a plurality of audio/video sources, wherein each of the plurality of audio/video sources is adapted to transmit signals in accordance with a different audio/video signal format, and to selectively convert any into a common signal format for subsequent transmission over a wireless link. Receiver unit 1304 is configured to receive the wirelessly-transmitted signal and to convert the wirelessly-received signal into a format suitable for wired transmission to audio/video sink 1406. As shown in FIG. 14, receiver unit 1304 also includes logic 1408 configured to extract an audio signal from the wirelessly-received signal and to provide the extracted audio signal to an audio/video receiver 1410 with associated speakers 1412 via an output interface, such as a wired S/PDIF or HDMI interface. The extracted signal may be provided to audio/video receiver 1410 instead of (or in addition to) being related to audio/video sink 1406. The extracted signal may also be provided to audio/video receiver 1410 via a wireless link.

### D. Conclusion

As noted above, an embodiment of the present invention is ideally suited for replacing a “brute force” expensive cabling strategy for home theater installation in which individual cables of potentially differing types are used to connect multiple pieces of audio/video source equipment to a single display. In place of multiple cables, one embodiment of the present invention takes inputs of various formats and interfaces, derives an equivalent internal signal (uncompressed or optionally compressed) that is capable of being transmitted over a wireless link, transmits the signal over the air, receives the signal at the receiver unit located in near proximity to the display, and produces an input-equivalent HDMI-formatted audio/video signal that is presented to the display via a wire. By replacing multiple input cables to the display with a single short HDMI cable, this embodiment of the invention greatly simplifies the installation of home theater systems.

With respect to the wireless connection between the audio/video switch and the wireless receiver unit, an embodiment of the present invention does not utilize a general-purpose solution based on IEEE 802.11a/b/g or 802.15.3a that fails to meet the throughput, quality and cost considerations of this application. Rather, the present invention utilizes a wireless solution that is described in pending U.S. patent application Ser. Nos. 11/117,467, 11/190,878, 11/211,082 and 11/216,173, each of which is incorporated by reference herein.

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. An audio/video switching system, comprising:
a transmitter unit configured to receive input signals from a plurality of audio/video sources, each of the plurality of audio/video sources being adapted to transmit signals in accordance with a different audio/video signal format, and to selectively convert any one of the input signals from its corresponding audio/video signal format into a common audio/video signal format and to wirelessly transmit the converted signal; and
a receiver unit configured to receive the wirelessly-transmitted signal and to convert the wirelessly-transmitted signal into an audio/video format suitable for wired transmission to an audio/video sink.

2. The audio/video switching system of claim 1, wherein the audio/video signal format suitable for wired transmission to the audio/video sink is a High Definition Multimedia Interface (HDMI) format.

3. The audio/video switching system of claim 1, wherein the audio/video signal format associated with the input signal selected for conversion is one of:
a High Definition Multimedia Interface (HDMI) format;
a Digital Video Interface (DVI) format;
a composite video (CVBS) format;
an S-video format;
a high definition or standard definition component video format;
a DisplayPort format;
a UDI format;
a digital audio format; or
an analog audio format.

4. The audio/video switching system of claim 1, wherein the audio/video sink is one of a display or an audio/video repeater.

5. The audio/video switching system of claim 1, further comprising:
an audio/video device;
wherein the transmitter unit is configured to extract an audio signal from a selected one of the input signals and to transmit the extracted audio signal to the audio/video device.

6. The audio/video switching system of claim 5, wherein the audio/video device comprises an audio/video receiver and wherein the extracted audio signal is a Sony/Philips Digital Interface (S/PDIF) or High Definition Multimedia Interface (HDMI) signal.

7. The audio/video switching system of claim 1, further comprising:
an audio/video device;
wherein the receiver unit is configured to extract an audio signal from the wirelessly-transmitted signal and to transmit the extracted audio signal to the audio/video device.

8. The audio/video switching system of claim 7, wherein the audio/video device comprises an audio/video receiver and wherein the extracted audio signal is a Sony/Philips Digital Interface (S/PDIF) or High Definition Multimedia Interface (HDMI) signal.

9. The audio/video switching system of claim 1, wherein the transmitter unit is configured to select one of the input signals for conversion and wireless transmission responsive to the receipt of a command from a user.

10. The audio/video switching system of claim 9, wherein the transmitter unit is configured to receive the command from the user via a sensor, wherein the sensor is adapted to receive an infrared or radio frequency signal from a remote control unit.

11. The audio/video switching system of claim 9, wherein the receiver unit is configured to receive the command from the user via a sensor and to forward the command to the transmitter unit via a wireless link.

12. The audio/video system of claim 1, wherein the transmitter unit includes an antenna for wirelessly transmitting the converted signal to the receiver unit, wherein the antenna is configured to allow the transmitter unit to be placed in a plurality of orientations.

13. The audio/video switching system of claim 1, wherein the transmitter unit comprises at least one multiple-type single-input interface for receiving one of the input signals.

14. A transmitter unit comprising:
a first interface configured to receive from a first audio/video source a first input signal having a first signal format;
a second interface configured to receive from a second audio/video source a second input signal having a second signal format, wherein the second signal format is different than the first signal format;
switching logic configured to selectively convert either the first input signal or the second input signal from its respective signal format to a common signal format; and
a third interface configured to wirelessly transmit the converted signal to a receiver unit connected to an audio/video sink.

15. The transmitter unit of claim 14, wherein the audio/video sink comprises a display or an audio/video repeater.

16. The transmitter unit of claim 14, wherein the signal format associated with either the first input signal or the second input signal is one of:
a High Definition Multimedia Interface (HDMI) format;
a Digital Video Interface (DVI) format;
a composite video (CVBS) format;
an S-video format;
a high definition or standard definition component video format;
a DisplayPort format;
a UDI format;
a digital audio format; or
an analog audio format.

17. The transmitter unit of claim 14, further comprising:
a fourth interface configured to receive a command from a user;
wherein the switching logic is configured to select either the first input signal or the second input signal for conversion responsive to the receipt of the user command.

18. The transmitter unit of claim 17, wherein the fourth interface includes a sensor for receiving an infrared or radio frequency signal from a remote control unit.

19. The transmitter of claim 17, wherein the fourth interface is configured to received the user command from the receiver unit.

20. The transmitter unit of claim 14, further comprising:
logic for extracting an audio signal from a selected one of the first input signal or the second input signal; and
a fourth interface configured to transmit the extracted audio signal to a device other than the audio/video sink.

21. The transmitter unit of claim 20, wherein the extracted audio signal is a Sony/Philips Digital Interface (S/PDIF) or High Definition Multimedia Interface (HDMI) signal.

22. An audio/video switching system comprising:
a first transmitter unit configured to receive a first plurality of input signals from a corresponding first plurality of audio/video sources and to selectively convert one of the first plurality of input signals into a format suitable for transmission over a first wireless link;
a second transmitter unit configured to receive a second plurality of input signals from a corresponding second plurality of audio/video sources and to selectively convert one of the second plurality of input signals into a format suitable for transmission over a second wireless link; and
a receiver unit configured to selectively receive either a signal transmitted from the first transmitter unit over the first wireless link or a signal transmitted from the second transmitter unit over the second wireless link and to convert the received signal into a format suitable for wired transmission to an audio/video sink.

23. The audio/video switching system of claim 22, wherein the first wireless link and the second wireless link comprise a spectrally-shared wireless link.

24. The audio/video switching system of claim 22, wherein the first wireless link and the second wireless link comprise separate spectrally-distinct wireless links.

25. The audio/video switching system of claim 22, wherein the receiver unit is configured to receive either the signal transmitted from the first transmitter unit over the first wireless link or the signal transmitted from the second transmitter unit over the second wireless link responsive to a command received from a remote control unit.

26. The audio/video switching system of claim 22, wherein the receiver unit is configured to wirelessly transmit a first command to the first transmitter unit to select one of the first plurality of input signals for conversion into a format suitable for transmission over the first wireless link and to wirelessly transmit a second command to the second transmitter unit to select one of the second plurality of input signals for conversion into a format suitable for transmission over the second wireless link.

27. The audio/video switching system of claim 26, wherein the receiver unit is configured to wirelessly transmit the first or second command in response to a third command received from a remote control unit.
